(19) United States
(12) Patent Application Publication
(10) Pub. No.: US 2026/0326588 A1
(43) Pub. Date: Oct. 22, 2026

(54) CHARGER FOR AN ELECTRIFIED VEHICLE

(71) Applicants: HYUNDAI MOTOR COMPANY, Seoul (KR); KIA CORPORATION, Seoul (KR); KYUNGSHIN CORP., Incheon (KR)

(72) Inventors: Yun Jae Jung, Hwaseong-si (KR); Taek You Kim, Incheon (KR)

(73) Assignees: HYUNDAI MOTOR COMPANY, Seoul (KR); KIA CORPORATION, Seoul (KR); KYUNGSHIN CORP., Incheon (KR)

(21) Appl. No.: 19/388,645

(22) Filed: Nov. 13, 2025

(30) Foreign Application Priority Data
Apr. 16, 2025 (KR) 10-2025-0049711

(51) Int. Cl. B60L 53/16; B60L 53/65; H01R 13/46; H01R 13/52; H01R 13/631; H01R 13/66; H01R 31/06

(52) U.S. Cl. CPC B60L 53/16; B60L 53/65; H01R 13/465; H01R 13/5219; H01R 13/631; H01R 13/6616; H01R 13/6683; H01R 31/065; H01R 2201/26

(57) ABSTRACT

A charger for an electrified vehicle includes a charging controller configured to be connected to the electrified vehicle or a charging source via a first connector, and a plurality of plugs each configured to be connected to the charging controller via a second connector selectively connected to the first connector. The second connector includes an identification resistor configured to enable the charging controller to distinguish between different types of the plugs.

### CROSS REFERENCE TO THE RELATED APPLICATION

This application claims the benefit of and priority to Korean Patent Application No. 10-2025-0049711 filed on Apr. 16, 2025 in the Korean Intellectual Property Office, the entire contents of which are hereby incorporated herein by reference.

### BACKGROUND

### Technical Field

The present disclosure relates to a charger for a vehicle that may effectively accommodate various charging sources.

### Description of Related Art

In pace with recently increased interest in the environment, use of an ecofriendly vehicle equipped with an electric motor as a power source is increasing. Such an ecofriendly vehicle is also referred to as an “electrified vehicle”. As representative examples of the electrified vehicle, there are a Hybrid Electric Vehicle (HEV), an Electric Vehicle (EV), and an Extended-Range Electric Vehicle (EREV).

Such an electrified vehicle is equipped with a battery configured to store electrical energy supplied from an external source or obtained through generation and to supply the stored electrical energy to a motor and electronic components. Systems for charging such a battery may be broadly classified into a portable charging system for charging a battery installed in a vehicle using a household or industrial AC power source and a charger, a slow charging system for slowly charging a battery installed in a vehicle through a charging stand, and a fast charging system for rapidly charging a battery installed in a vehicle through an electric vehicle charging station.

In particular, in the case of the portable charging system, an In-Cable Control Box (ICCB), which is a charging controller equipped with a communication function with an electrified vehicle and a charging state control function, may be incorporated in the charger.

Plugs used to receive electric power from charging sources may be diverse in accordance with maximum allowable current values of the charging sources and the connector standards specific to each country.

The above matters described in this Background section are merely for enhancement of understanding of the general background of the present disclosure and should not be taken as an acknowledgement or any form of suggestion that the matters form the related art already known to a person having ordinary skill in the art.

### SUMMARY

The present disclosure has been made in view of the above problems. Aspects of the present disclosure provide a charger for an electrified vehicle that is configured to be compatible with various types of plugs, to distinguish between different plug types, and to effectively control a charging state.

Aspects of the present disclosure provide a charger for an electrified vehicle capable of accommodating various types of plugs using a single ICCB.

Aspects of the present disclosure are not limited to the above-described aspects. Other aspects of the present disclosure not mentioned herein should be more clearly understood by those having ordinary skill in the art from the following detailed description.

In accordance with an aspect of the present disclosure, a charger for an electrified vehicle is provided. The charger includes a controller configured to be connected to the electrified vehicle or a charging source via a first connector. The charger also includes a plurality of plugs, each plug configured to be connected to the controller via a second connector configured to be selectively connected to the first connector. The second connector includes an identification resistor configured to enable the controller to distinguish between different types of the plugs.

In a disclosed embodiment, the second connector may include a connection portion configured to be electrically connected to the first connector. The connection portion may have a uniform shape irrespective of the types of the plugs.

In a disclosed embodiment, the identification resistor may be configured to have a resistance value selected from among different resistance values respectively corresponding to the types of the plugs.

In a disclosed embodiment, respective plugs, among the plurality of plugs, are configured to be distinguished from one another in accordance with maximum allowable charging current values of the plugs. The identification resistor may have a smaller resistance value for a larger maximum allowable charging current value.

In a disclosed embodiment, the second connector may further include a temperature sensor configured to measure a temperature of engagement portions of the connectors. The controller may be further configured to determine the temperature of engagement portions of the connectors by being connected to the temperature sensor and determine a current amount limit based on the temperature, based on engagement of the first connector with the second connector.

In a disclosed embodiment, the temperature sensor may comprise a negative temperature coefficient (NTC) element.

In a disclosed embodiment, based on engagement of the first connector with the second connector, the first connector may be connected to a power circuit configured to supply AC power and a resistance identification circuit comprising the identification resistor. The first connector may be configured such that connection to the power circuit may be made before the connection to the resistance identification circuit.

In a disclosed embodiment, the controller may wake up based on the connection of the power circuit being made, and may control charging not to be performed based on the connection of the power circuit being made but the connection of the resistance identification circuit not being made.

In a disclosed embodiment, the controller may further include a switch connected in series to the power circuit, and the controller may control whether charging of the electrified vehicle is to be performed, by controlling the switch.

In a disclosed embodiment, the controller may determine a current amount limit based on a resistance value of the identification resistor.

In a disclosed embodiment, the controller may determine a current amount limit to have a smaller value for a greater resistance value of the identification resistor.

In a disclosed embodiment, the first connector may include a plurality of connector pins, each connector pin having a first end connected to the controller and a second end selectively connected to the first connector. The first end of each of the plurality of connector pins may have a greater diameter than the second end of each of the plurality of connector pins.

In a disclosed embodiment, the second connector may further include: a plurality of terminals, each terminal having i) a first end configured to be connected to a corresponding one of the plugs or the identification resistor and ii) a second end selectively connected to the second connector; a first molding configured to enclose the first end of each of the plurality of terminals; and a second molding configured to enclose the second end of each of the plurality of terminals and the first molding. The second connector may further include a plurality of seals configured to maintain sealing between respective second ends of the plurality of terminals and the second molding.

In a disclosed embodiment, the first connector and the second connector may further include a protrusion and a groove configured to i) be engaged with each other based on the first connector being engaged with the second inverter and ii) be misaligned from each other in other states of the first and second connectors.

In a disclosed embodiment, the first connector may include the groove, and the second connector may include the protrusion.

In a disclosed embodiment, the charger may further include a connector seal configured to maintain sealing when the first connector is engaged with the second connector.

In a disclosed embodiment, the connector seal may have a color distinguished from colors of the first connector and the second connector. The connector seal may be hidden based on the first connector being fully engaged with the second connector, and to be exposed based on other states of the first and second connectors.

In a disclosed embodiment, the connector seal may surround a periphery of the second connector, and may be attached to an outer wall of the second connector so as to be disposed between the first connector and the second connector, when the first connector and the second connector are engaged.

In a disclosed embodiment, the connector seal may be configured to i) be attached to the first connector and ii) be disposed between the first connector and the second connector based on the first connector being engaged with the second connector.

In a disclosed embodiment, the connector seal may be configured to i) be attached to the first connector and ii) be disposed between two facing surfaces of the first and second connectors based on the first connector being engaged with the second connector.

### BRIEF DESCRIPTION OF THE DRAWINGS

The above and other aspects, features, and other advantages of the present disclosure should be more clearly understood from the following detailed description taken in conjunction with the accompanying drawings, in which:

FIG. 1 is a block diagram showing a vehicle charger according to an embodiment of the present disclosure, a charging source, and an electrified vehicle;

FIG. 2 is a diagram illustrating a second connector, according to an embodiment of the present disclosure;

FIG. 3 is an exploded view showing individual components of the second connector, according to an embodiment of the present disclosure;

FIG. 4 is a view showing a first connector, according to an embodiment of the present disclosure;

FIG. 5 is a view showing a block and a case included in the first connector, according to an embodiment of the present disclosure;

FIG. 6 is a view showing individual components of the block of the first connector, according to an embodiment of the present disclosure;

FIG. 7 is a view showing an example of a cross-section of the second connector, according to an embodiment of the present disclosure;

FIG. 8 is a view showing an example of a cross-section of the first connector, according to an embodiment of the present disclosure;

FIG. 9 is a view showing an example of a connector seal applied to engagement portions of the first connector and the second connector, according to an embodiment of the present disclosure;

FIG. 10 is a view showing seals configured to maintain sealing at the second connector, according to an embodiment of the present disclosure;

FIG. 11 is a view showing a cross-section of the first connector, according to an embodiment of the present disclosure;

FIG. 12 is a view showing a cross-section including the first connector, the second connector, and the connector seal, according to an embodiment of the present disclosure; and

FIG. 13 is a view showing another embodiment of the connector seal.

### DETAILED DESCRIPTION

Hereinafter, embodiments of the present disclosure are described in detail with reference to the accompanying drawings. The same or similar elements are designated by the same reference numerals regardless of the drawing numerals and redundant description thereof have been omitted. The suffixes “module” and “unit” of elements herein are used for convenience of description and thus may be used interchangeably and do not have any distinguishable meanings or functions. In the following description of the embodiments of the present disclosure, wherein it was determined that a detailed description of known functions and configurations would obscure the gist of the present disclosure, the detailed description thereof has been omitted. Embodiments of the present disclosure should be more clearly understood from the accompanying drawings. However, the present disclosure is not limited by the accompanying drawings, and it is to be appreciated that all changes, equivalents, and substitutes that do not depart from the spirit and technical scope of the present disclosure are encompassed in the present disclosure.

It should be understood that, although the terms “first,” “second,” etc. may be used herein to describe various elements, these elements are not limited by these terms. These terms are only used to distinguish one element from another.

In the case where an element is “connected” or “linked” to another element, it should be understood that the element may be directly connected or linked to the other element, or another element may be present therebetween. Conversely, in the case where an element is “directly connected” or “directly linked” to another element, it should be understood that no other element is present therebetween.

Unless clearly used otherwise, singular expressions include a plural meaning.

In this specification, the term “comprising,” “including,” or the like, is intended to express the existence of the characteristic, the numeral, the step, the operation, the element, the part, or the combination thereof, and does not exclude another characteristic, numeral, step, operation, element, part, or any combination thereof, or any addition thereto.

When a component, controller, device, element, unit, apparatus, or the like of the present disclosure is described as having a purpose or performing an operation, function, or the like, the component, controller, device, element, unit, apparatus, or the like should be considered herein as being “configured to” meet that purpose or to perform that operation or function. Each component, controller, device, element, unit, apparatus, and the like may separately embody or be included with a processor and a memory, such as a non-transitory computer readable media, as part of the apparatus.

The term “~controller” used in the present disclosure may mean include software, firmware, and/or hardware components, and the “controller” performs certain roles. The components may include resistors, transistors, switches and/or the like to perform the described operations. The components may include integrated circuits, such as a field-programmable gate array (FPGA) or an application specific integrated circuit (ASIC). However, the “~controller” is not limited to software, firmware, or hardware. At least a portion of the “~controller” may reside on an addressable storage medium and configured to reproduce one or more processors. The “~controller” may include components such as software components, object-oriented software components, class components, and task components, processes, functions, attributes, procedures, subroutines, segments of program code, drivers, firmware, microcode, circuits, data, database, data structures, tables, arrays, and variables.

Hereinafter, embodiments of the present disclosure are described in detail with reference to the accompanying drawings.

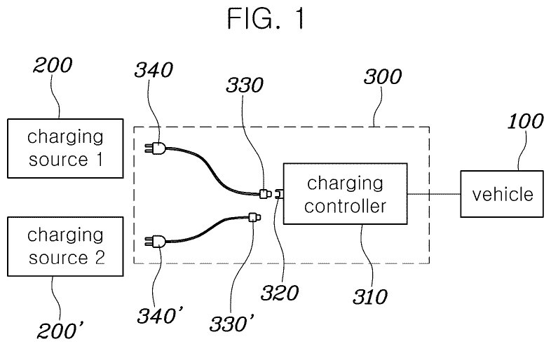

FIG. 1 is a block diagram showing a vehicle charger according to an embodiment of the present disclosure, a charging source, and an electrified vehicle.

Referring to FIG. 1, a vehicle charger 300 may include a charging controller 310 (sometimes referred to herein as simply “controller”), a plurality of plugs 340 and 340′, a first connector 320, and a plurality of second connectors 330 and 330′. The vehicle charger 300 may be connected to a vehicle 100 and a plurality of charging sources 200 and 200′.

The vehicle 100 may be equipped with an inlet (not shown) that is a charging terminal. One end of the charger 300 may be connected to an outlet (not shown), that is a plug connectable to the inlet, to supply power to the vehicle 100.

Additionally, the other end of the charger 300 may be connected to one of the plurality of plugs 340 and 340′, each of which is used to receive AC power from a corresponding one of the plurality of charging sources 200 and 200′.

The charging controller 310 may selectively supply charging power to the vehicle 100 through an AC power source. The charging controller 310 may limit a charging current amount. The charging controller 310 may also monitor the status of the charger 300.

The charging controller 310 may be connected to the first connector 320. The plug-1 340 configured to receive power from the charging source-1 200 may be connected to the second connector 330 corresponding thereto. The first connector 320 and the second connector 330 may be selectively engaged to supply power obtained from the charging source-1 200 to the vehicle 100 through the charging controller 310.

Similarly, the first connector 320 may be engaged with the second connector 330′ corresponding to the plug-2 340′ configured to receive power from the charging source-2 200′.

Hereafter, for convenience, it is assumed that the vehicle 100 is charged through the plug-1 340 and the second connector 330 corresponding thereto by receiving power from the charging source-1 200, unless otherwise specified.

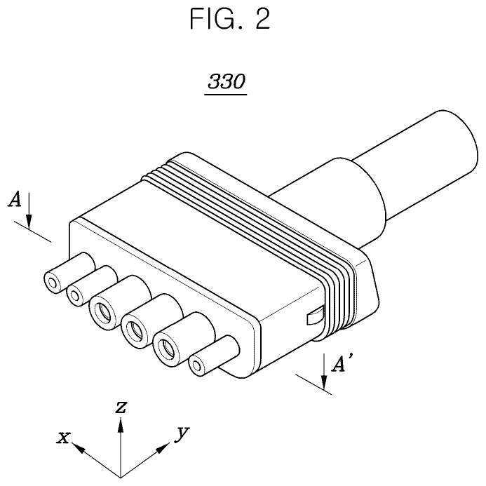

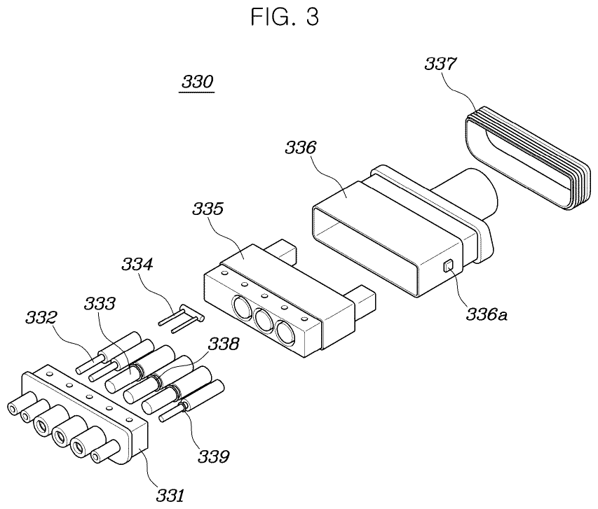

FIG. 2 is a diagram illustrating the second connector according to an embodiment. FIG. 3 is an exploded view showing individual components of the second connector according to an embodiment.

Referring to FIGS. 2 and 3, the second connector 330 may include a plurality of terminals 332 and 333. The terminal 332 may be connected to an identification resistor 334 or a temperature sensor (not shown) constituted by a negative temperature coefficient (NTC) element. The terminal 333 may be connected to the plug 340.

The plurality of terminals 332 and 333 may be enclosed by a first molding 335. The first molding 335 may be enclosed by second moldings 331 and 336. The molding 331 may be configured to enclose a connection portion connected to the second connector 330. The molding 336 may be configured to enclose the first molding 335.

Additionally, the second connector 330 may further include a connector seal 337 configured to maintain sealing between the first connector 320 and the second connector 330, and a plurality of seals 338 and 339 configured to maintain sealing of the second connector 330.

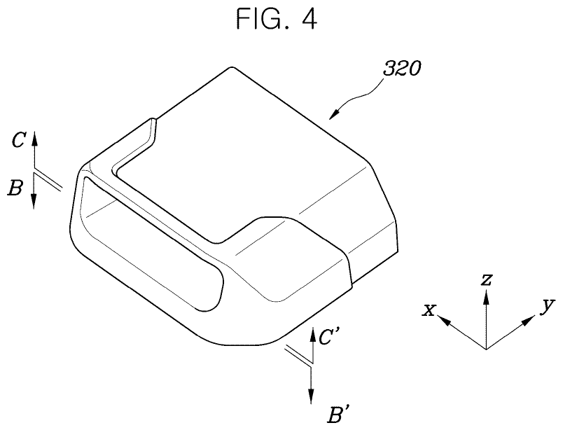

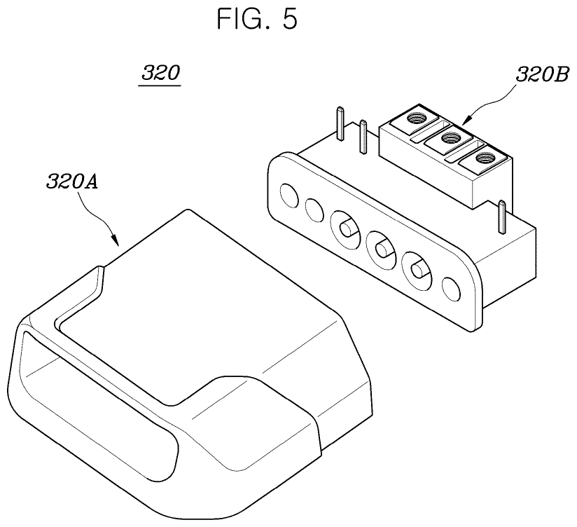

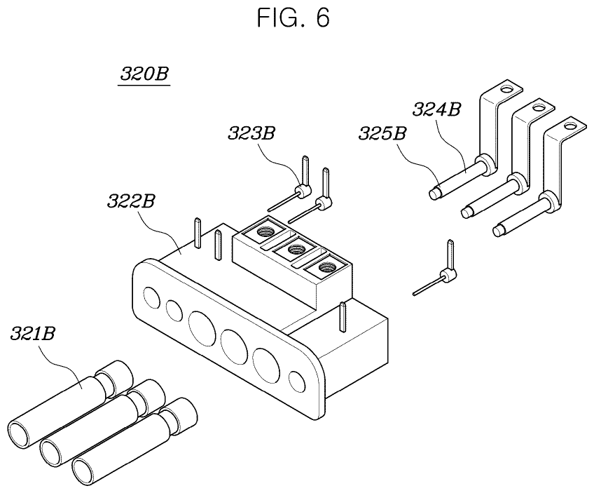

FIG. 4 is a view showing the first connector according to an embodiment. FIG. 5 is a view showing a block and a case included in the first connector according to an embodiment. FIG. 6 is a view showing individual components of the block of the first connector according to an embodiment.

Referring to FIGS. 4 and 5, the first connector 320 may include a block 310B and a case 310A. The case 310A may be configured to enclose the block 310B and to be coupled to the second connector 330 in a fitting manner.

Referring to FIG. 6, the block 310B of the first connector 320 may include a plurality of connector pins 323B connected to the identification resistor 334 and the temperature sensor, and a plurality of connector pins 324B configured to receive AC power from the charging source 200. The plurality of connector pins 323B and 324B may be enclosed by a housing 322B. The plurality of connector pins 324B, which receives AC power, may be additionally protected by a metal bushing 321B and a cap 325B made of an insulating material.

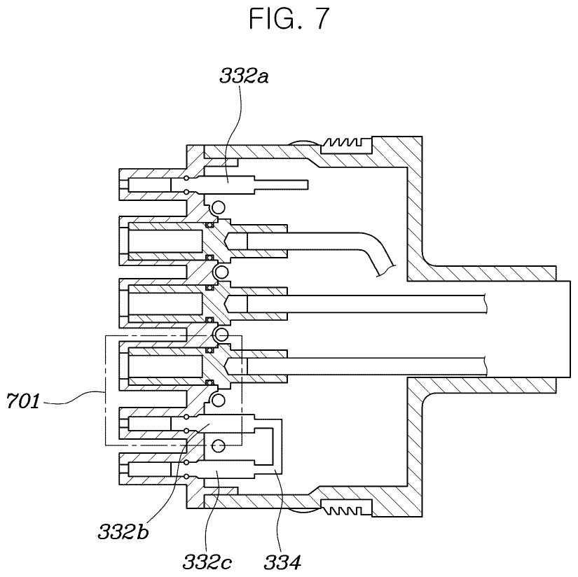

FIG. 7 is a view showing an example of a cross-section of the second connector according to an embodiment.

Referring to FIG. 7, an example of a cross-section of the second connector 330, which is taken along line A-A′ in FIG. 2 and is parallel to an xy-plane.

One terminal 332a among the terminals 332, which are not connected to a power supply source, may be connected to the temperature sensor. When the first connector 320 is engaged with the second connector 330, the temperature sensor may be connected to the charging controller 310. The charging controller 310 may measure a temperature at engagement portions of the first connector 320 and the second connector 330 through the temperature sensor, and may determine a current amount limit in order to prevent the engagement portions from overheating.

For example, in the case in which the charging controller 310 limits the charging current to half of the current charging current amount in order to prevent the temperature of the engagement portions from rising further, the amount of heat generated at the engagement portions may be reduced to ¼ of the current heat amount because the power loss caused by electrical resistance is proportional to the square of the current amount.

Another pair of terminals 332b and 332c may be connected to the identification resistor 334. When the first connector 320 and the second connector 330 are engaged, a resistance identification circuit including the identification resistor 334 may be connected to an internal configuration of the charger 300. The charging controller 310 may measure a resistance value of the identification resistor 334 included in the resistance identification circuit.

Since the plurality of charging sources 200 and 200′ have different values of maximum allowable current, values of maximum allowable charging current of the corresponding plugs 340 and 340′ may also be different. Therefore, it may be necessary for the charging controller 310 to determine a current amount limit based on the maximum allowable charging current.

To achieve this, the plurality of second connectors 330 and 330′ may include identification resistors 334 with different resistance values, respectively. For example, for a larger maximum allowable charging current value of the plug 340, the identification resistor 334 included in the corresponding second connector 330 may have a smaller resistance value.

In this case, even when the charging controller 310 erroneously identifies the resistance value of the identification resistor 334 as a higher value than an actual value due to foreign matter, etc. between the first connector 320 and the second connector 330, the charging controller 310 may determine the current amount limit to be smaller than the maximum allowable charging current of the plug 340. Accordingly, it may be possible to prevent safety issues caused by erroneous resistance identification.

Additionally, by distinguishing the type of the plug 340 using the identification resistor 334 while maintaining the physical shape of the second connector 330 and the arrangement of the plurality of connector pins 323B and 324B to be constant irrespective of the type of the plug 340, an enhancement in efficiency may be achieved in association with mass production of the charger 300.

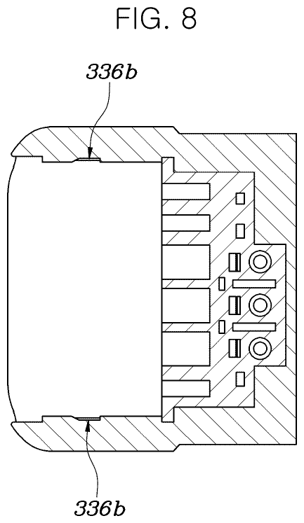

FIG. 8 is a view showing an example of a cross-section of the first connector according to an embodiment.

Referring to FIG. 8, an example of a cross-section of the first connector 320, which is taken along line C-C′ in FIG. 4 and is parallel to an xy-plane. For convenience, components unrelated to the description of a groove 336b are briefly presented.

The first connector 320 according to the disclosed embodiment may include a case 320A (FIG. 5). The case 320A may include a groove 336b configured to be engageable with a protrusion 336a of the second connector 330. When the first connector 320 and the second connector 330 are fully engaged, the groove 336b and the protrusion 336a are engaged. In other states, the groove 336b and the protrusion 336a may be misaligned. Accordingly, it may be possible to verify the engagement or the misalignment through auditory and tactile feedback.

However, it is also possible to modify the configuration so that the second connector 330 includes the protrusion 336a and the first connector 320 includes the groove 336b (not shown).

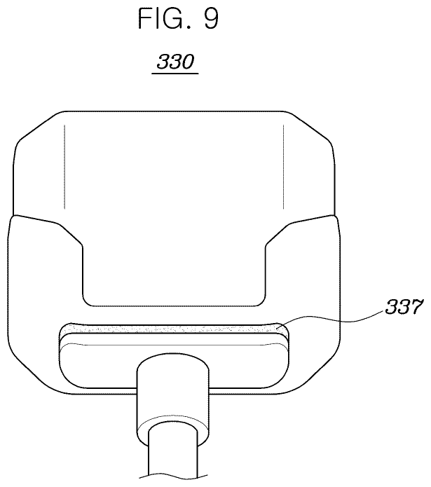

FIG. 9 is a view showing an example of a connector seal applied to the engagement portions of the first connector and the second connector according to an embodiment.

Referring to FIG. 9, the second connector 330 may include a connector seal 337 configured to maintain sealing at the engagement portion of the second connector 330 when the second connector 330 is engaged with the first connector 320. Additionally, the connector seal 337 may have a color different from those of the first connector 320 and the second connector 330.

When the first connector 320 is fully engaged with the second connector 330, the connector seal 337 may be completely hidden by the case 320A of the first connector 320. However, in a state in which the first and second connectors 320 and 330 are not fully engaged, a part of the connector seal 337 may be exposed externally. This allows users to visually verify whether the first connector 320 and the second connector 330 are fully engaged.

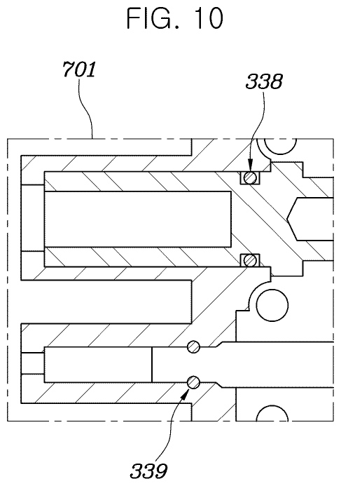

FIG. 10 is a view showing seals configured to maintain sealing at the second connector according to an embodiment.

Referring to FIG. 10, an enlarged cross-sectional view of a portion 701 of the cross-section in FIG. 7 is shown. Since the plurality of terminals 332 and 333 is partially exposed to enable electrical connection thereof to the plurality of connector pins 323B and 324B of the first connector 320, moisture, dust, etc. may enter junctions between the plurality of terminals 332 and 333 and the second moldings 331 and 336. To this end, the plurality of seals 338 and 339 may be provided at the junctions to enhance durability.

As an example implementing the plurality of seals 338 and 339, a plurality of O-rings having elasticity may be inserted between the plurality of terminals 332 and 333 and the second moldings 331 and 336.

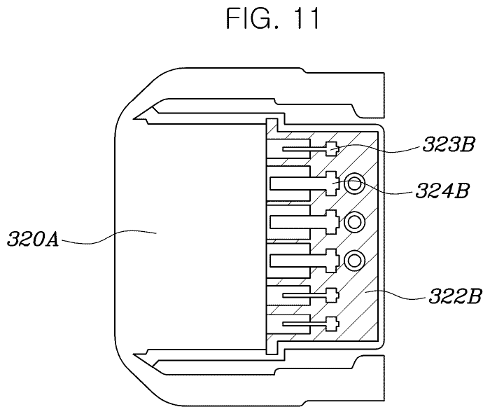

FIG. 11 is a view showing a cross-section of the first connector according to an embodiment.

Referring to FIG. 11, an example of the cross-section of the first connector 320, which is taken along line B-B′ in FIG. 4 and is parallel to an xy-plane. The first connector 320 may include a plurality of connector pins 323B and 324B. Each of the plurality of connector pins 323B and 324B may always be connected, at one end thereof, to the charging controller 310, and is selectively connected, at the other end thereof, to a corresponding one of the plurality of terminals 332 and 333 of the first connector 320.

The one end of each of the multiple connector pins 323B and 324B is enclosed by the housing 322B, but the other end of each of the multiple connector pins 323B and 324B is exposed to the outside and, as such, may allow introduction of moisture, dust, etc. To prevent introduction of moisture, dust, etc., each of the multiple connector pins 323B and 324B may be configured to provide a step between both ends thereof. For example, each of the multiple connector pins 323B and 324B may be configured such that the diameter of the one end thereof is greater than the diameter of the other end thereof.

Additionally, among the multiple connector pins 323B and 324B, the connector pins 323B connected to the identification resistor 334 and the temperature sensor may have a length different from that of the connector pins 324B configured to receive AC power. Accordingly, when the first connector 320 and the second connector 330 are engaged, a power circuit may first be connected, and the resistance identification circuit and a temperature sensor circuit may then be connected.

When the power circuit is connected, the charging controller 310 may wake up. In a state in which the power circuit is connected, but both the resistance detection circuit and the temperature sensor circuit are not yet connected, the charging controller 310 may determine a charging state as a charging standby state and, as such, may limit charging current.

When both the resistance identification circuit and the temperature sensor circuit are subsequently connected in addition to connection of the power circuit, the charging controller 310 may determine a charging amount limit based on the resistance value of the identification resistor 334 in the resistance identification circuit, may determine the charging state as a charging start state, and may supply, to the vehicle 100, charging current within the charging amount limit.

In an embodiment of a method of controlling charging current by the charging controller 310, the charging controller 310 may include a switch (not shown) connected in series to the power circuit and, as such, may control charging current by controlling an on/off state of the switch.

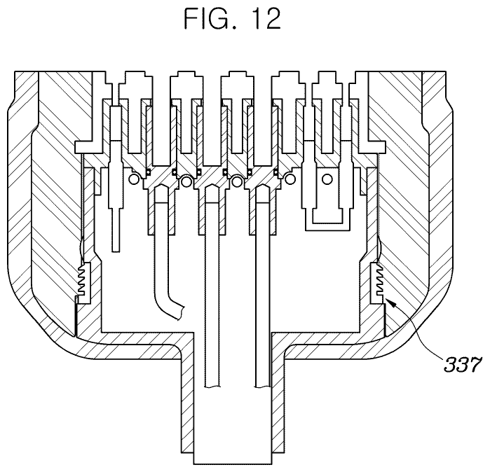

FIG. 12 is a view showing a cross-section including the first connector, the second connector, and the connector seal according to the disclosed embodiment.

Referring to FIG. 12, a cross-section taken along line C-C′ in FIG. 4 and is parallel to an xy-plane in a state in which the first connector 320 and the second connector 330 are engaged.

The charger 300 may further include the connector seal 337 configured to prevent introduction of moisture, dust, etc. between the engagement portions of the first connector 320 and the second connector 330.

In an embodiment, the connector seal 337 may surround the periphery of the second connector 330, and may be attached to an outer wall of the second connector 330 so as to be disposed between the first connector 320 and the second connector 330, when the first connector 320 and the second connector 330 are engaged.

In another embodiment, a connector seal (not shown) may be attached to an inner surface of the case 320A such that, when the first connector 320 and the second connector 330 are engaged, the connector seal is disposed between the first connector 320 and the second connector 330 while surrounding the periphery of the second connector 330.

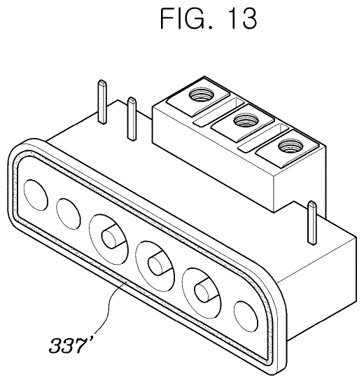

FIG. 13 is a view showing another embodiment of the connector seal.

Referring to FIG. 13, an embodiment of a connector seal 337′ attached to the housing 322B of the first connector 320 is shown. The connector seal 337′ may be attached to an engagement portion of the housing 322B so that, when the first connector 320 is engaged with the second connector 330, the connector seal 337′ is disposed between two facing surfaces of the connectors 320 and 330. For example, the connector seal 337′, which is made of an elastic material such as rubber or the like, may be attached to the housing 322B. In this case, when the connectors 320 and 330 are engaged, the connector seal 337′ may be deformed to fill any gap between the engagement portions of the connectors 320 and 330.

As apparent from the above description, the charging controller included in the charger according to embodiments of the present disclosure may be connected to various types of plugs, and may appropriately control a charging state in accordance with the types of the plugs. Additionally, sealing may be maintained between the connectors both before and after connection, resulting in high durability. Through these features, it may be possible to provide an economical and safe vehicle charger.

Effects attainable in embodiments of the present disclosure are not limited to the above-described effects. Other effects of the present disclosure not described herein should be more clearly understood by those having ordinary skill in the art from the above description.

Although example embodiments of the present disclosure have been described for illustrative purposes, those having ordinary skill in the art should appreciate that various modifications, additions, and substitutions are possible, without departing from the scope and spirit of the disclosure as disclosed in the accompanying claims.

What is claimed is:

1. A charger for an electrified vehicle, the charger comprising:
a controller configured to be connected to the electrified vehicle or a charging source via a first connector; and
a plurality of plugs, each plug configured to be connected to the controller via a second connector configured to be selectively connected to the first connector,
wherein the second connector comprises an identification resistor configured to enable the controller to distinguish between different types of the plugs.

2. The charger according to claim 1, wherein:
the second connector further comprises a connection portion configured to be electrically connected to the first connector; and
the connection portion is configured to have a uniform shape irrespective of the types of the plugs.

3. The charger according to claim 1, wherein the identification resistor is configured to have a resistance value selected from among different resistance values respectively corresponding to the types of the plugs.

4. The charger according to claim 1, wherein:
respective plugs, among the plurality of plugs, are configured to be distinguished from one another in accordance with maximum allowable charging current values of the plugs; and
the identification resistor is further configured to have a smaller resistance value for a larger maximum allowable charging current value.

5. The charger according to claim 1, wherein:
the second connector further comprises a temperature sensor configured to measure a temperature of engagement portions of the connectors; and
the controller is further configured to:
determine the temperature of engagement portions of the connectors by being connected to the temperature sensor, and
determine a current amount limit based on the temperature, based on engagement of the first connector with the second connector.

6. The charger according to claim 5, wherein the temperature sensor comprises a negative temperature coefficient (NTC) element.

7. The charger according to claim 1, wherein, based on engagement of the first connector with the second connector, the first connector is configured to be connected to a power circuit to supply AC power and a resistance identification circuit comprising the identification resistor, and wherein the first connector is configured such that a connection to the power circuit is made before a connection to the resistance identification circuit.

8. The charger according to claim 7, wherein the controller is configured to:
wake up based on the connection of the power circuit being made; and
control charging not to be performed based on the connection of the power circuit being made but the connection of the resistance identification circuit not being made.

9. The charger according to claim 7, wherein:
the controller further comprises a switch connected in series to the power circuit, and
the controller is further configured to control whether charging of the electrified vehicle is to be performed, by controlling the switch.

10. The charger according to claim 1, wherein the controller is further configured to determine a current amount limit based on a resistance value of the identification resistor.

11. The charger according to claim 1, wherein the controller is further configured to determine a current amount limit to have a smaller value for a greater resistance value of the identification resistor.

12. The charger according to claim 1, wherein:
the first connector comprises a plurality of connector pins, each connector pin having i) a first end configured to be connected to the controller and ii) a second end configured to be selectively connected to the first connector; and
the first end of each of the plurality of connector pins is configured to have a greater diameter than the second end of each of the plurality of connector pins.

13. The charger according to claim 1, wherein:
the second connector further comprises:
a plurality of terminals, each terminal configured to have a first end connected to a corresponding one of the plugs or the identification resistor and a second end selectively connected to the second connector;
a first molding configured to enclose the first end of each of the plurality of terminals; and
a second molding configured to enclose the second end of each of the plurality of terminals and the first molding; and
the second connector further comprises a plurality of seals configured to maintain sealing between respective second ends of the plurality of terminals and the second molding.

14. The charger according to claim 7, wherein the first connector and the second connector further comprise a protrusion and a groove configured to i) be engaged with each other based on the first connector being engaged with the second connector and ii) be misaligned from each other in other states of the first and second connectors.

15. The charger according to claim 14, wherein:
the first connector comprises the groove; and
the second connector comprises the protrusion.

16. The charger according to claim 1, further comprising a connector seal configured to maintain sealing when the first connector is engaged with the second connector.

17. The charger according to claim 16, wherein:
the connector seal is configured to have a color distinguished from colors of the first connector and the second connector; and
the connector seal is further configured to i) be hidden based on the first connector being fully engaged with the second connector and ii) be exposed based on other states of the first and second connectors.

18. The charger according to claim 16, wherein the connector seal is configured to i) surround a periphery of the second connector and ii) be attached to an outer wall of the second connector so as to be disposed between the first connector and the second connector based on the first connector and the second connector are engaged.

19. The charger according to claim 16, wherein the connector seal is further configured to i) be attached to the first connector and ii) be disposed between the first connector and the second connector based on the first connector being engaged with the second connector.

20. The charger according to claim 16, wherein the connector seal is further configured to i) be attached to the first connector and ii) be disposed between two facing surfaces of the first and second connectors based on the first connector being engaged with the second connector.
